(19) United States
(12) Patent Application Publication
(10) Pub. No.: US 2009/0121970 A1
(43) Pub. Date: May 14, 2009

(54) HOUSEHOLD APPLIANCE

(76) Inventor: Mehmet Ozbek, Istanbul (TR)

Correspondence Address: VENABLE, CAMPILLO, LOGAN & MEANEY, P.C., 1938 E. OSBORN RD, PHOENIX, AZ, 85016-7234, US

(21) Appl. No.: 11/574,130

(22) PCT Filed: Aug. 25, 2005
(86) PCT No.: PCT/IB2005/005794

§ 371 Date: Feb. 22, 2007

(30) Foreign Application Priority Data
Aug. 27, 2004 (TR) 2004/02150

(51) Int. Cl. G09G 5/00

(52) U.S. Cl. 345/4

(57) ABSTRACT

This invention relates to a household appliance (1) comprising a display unit (6) installed thereon.

This invention relates to a household appliance comprising a display unit which enables the user to easily follow the operation status thereof.

In almost all household appliances, for example washing machines, clothes dryers, dishwashers, cooking appliances and coolers, there are display units enabling the display of the information allowing the user to monitor the operation status of the appliance and to control the appliance more easily preferably liquid crystal display units are employed as display. In the current state of the art, employment of transparent or semi-transparent LCDs which partially or fully allow light to pass through is known.

LCDs are preferably positioned on the appliance within a control panel which also includes the control keys by which the user can control operation of appliance. Although the information displayed on the LCD engaged on the control panel is in viewable size when user is near the appliance, information displayed on the LCD cannot be easily viewed when user goes away from the appliance.

Various methods have been developed for easy viewing of the operation status of the appliance by the user.

In the current state of the art, in the European Patent Application no. 1207353, an apparatus is described wherein the operation status information is reflected on a wall by means of a projection device.

In another state of the art, in the United States Patent Application no. 2002007486 and U.S. Pat. Nos. 6,692,093 and 6,430,946, LCD screens positioned on a cooling apparatus is described.

In another state of the art, in the International Patent Application no. 200214593, a control and display panel on the door of a front-load washing machine which enables user to monitor operation steps from a distance is described.

In another state of the art, in the International Patent Application no. 2004057636, a device which displays the operation status of the appliance to the user by implementing various colour signals is described.

The object of this invention is the realisation of a household appliance comprising a display unit which allows the user to easily view the operation status of the appliance.

The household appliance designed to fulfill the object of the present invention is illustrated in the attached figures wherein:

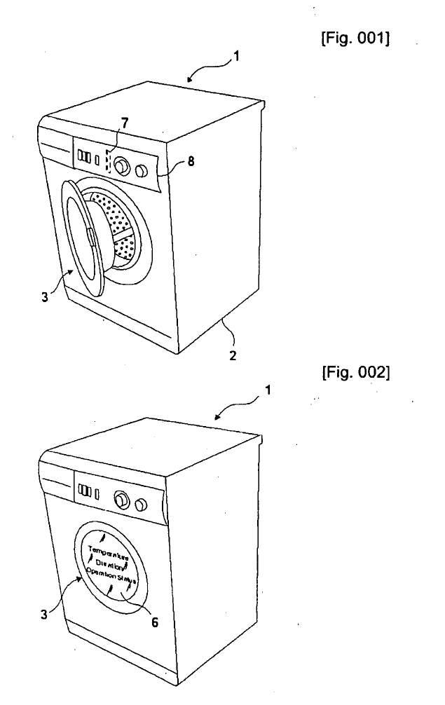

FIG. 1—is the perspective view of a washer dryer in the preferred embodiment of the present invention.

FIG. 2—is the perspective view of a washer dryer when the display is active.

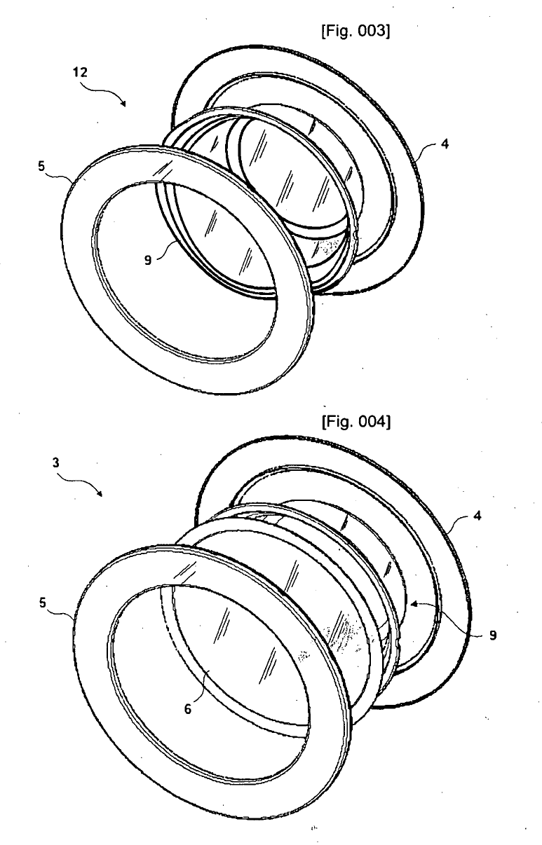

FIG. 3—is the exploded view of a window.

FIG. 4—is the exploded view of washer dryer door.

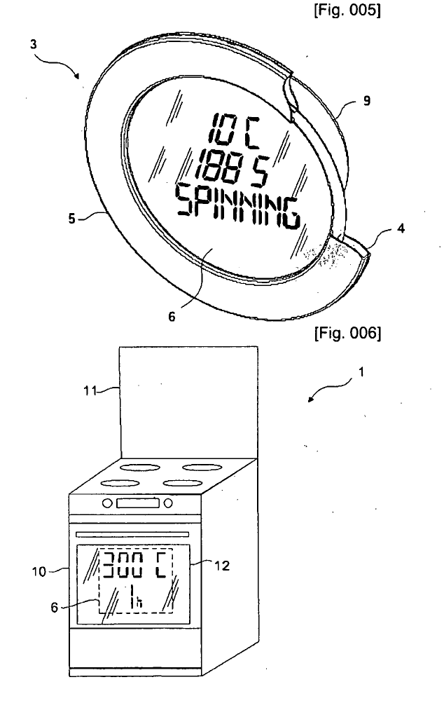

FIG. 5—is the perspective view of a washer dryer door.

FIG. 6—is the perspective view of an active display unit disposed on the front door of a cooking appliance in an alternative embodiment of the present invention.

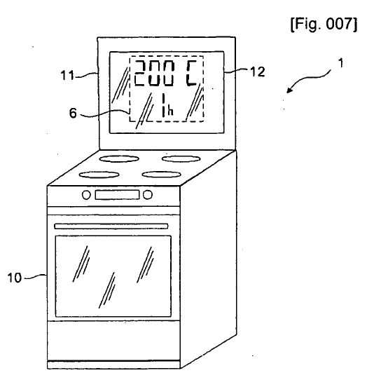

FIG. 7—is the perspective view of an active display unit disposed on the upper door of a cooking appliance in an alternative embodiment of the present invention.

The elements shown in figures are numbered as follows:
1. Household appliance
2. Body
3. Door
4. Inner frame
5. Outer frame
6. Display unit
7. Control card
8. Control panel
9. Panel
10. Front door
11. Upper door
12. Window

The household appliance (1) which is the object of the present invention, for example a washer dryer (washing machines, clothes dryers and dishwashers), a cooking appliance or a cooling appliance, comprises a body (2), a door (3) attached on the body (1) enabling user to have access inside the body (2), a window (12) positioned on the body (2) and/or the door (3) allowing user to view interior of the body (2), a hinge enabling the door (3) to be installed on the body (2) and the opening and closing of it, a control panel (8) comprising a data entry unit like buttons, keys or a keypad and a display, a screen or the like data output unit enabling the user to control the household appliance (1), a control card (7) enabling the control of the household appliance (1), and unlike data output unit on control panel (8), a display unit (6) secured on the window (12) allowing the user to monitor simultaneously the interior of the body (2) through the window (12) and the data delivered by the control card (7) (all the data relating to the appliance and the current condition of the appliance like temperature, duration, operation status-of-appliance etc.).

The data exchange between the display unit (6) installed on the household appliance (1) and the control card (7) which processes data to be displayed on the display unit (6) can be accomplished through mechanical and electrical connections like cable connections etc. as well as by employing state of the art wireless data exchange methods (infrared, radio signal, bluetooth etc.) without the need for mechanical connections.

For the purpose of monitoring interior of the household appliance (1) by the user, the window (12) is produced prefer ably of glass or a similar transparent material that allows light to pass through.

The display unit (6) is produced of a transparent or semi-transparent material enabling the user to view behind the display unit (6).

LCD is preferably employed as the display unit (6) because it exhibits a transparent characteristic which lets the light pass through. The display unit (6) comprises a liquid crystal material placed between two glass panels and isolated from outer medium and at least one guider or polarizer placed in double layer on the glass panels which filters and thus directs the light and at least one light source.

In the preferred embodiment of the present invention, the transparent display unit (6) is disposed on the door (3) to enable the user to monitor interior of the household appliance (1). The display unit (6) is engaged on the door (3) by the state of the art attachment methods like fixing elements or snap-fitting method or adhesion. The (3) having the display unit (6) mounted on it is installed on the body (2) by means of a hinge. The display unit (6) as well as being engaged on the door (3) may also be engaged on the window (12) which is on the body (2) and which is made of a transparent or semi transparent material allowing the user to monitor interior of the household appliance (1) or the current condition of the household appliance (1). Thus, while the user monitors the interior of the house appliance (1), the data related to the household appliance (1) like operation status, current program, remaining time etc. may also be monitored.

In the preferred embodiment of the household appliance (1), which is the object of the present invention, a washer dryer specifically a washing machine is employed. The door (3) of the washing machine comprises an inner frame (4), an outer frame (5) and a panel (9) interposed between the inner frame (4) and the outer frame (5) preferably made of glass. A display unit (6) utilizing transparent LCD is engaged between the panel (9) and the outer frame (5). Display unit (6) engaged between the panel (9) and the outer frame (5) is mounted on the inner frame (4) by way of various attachment methods to form the washing machine door (3). The door (3) is fixed on the body (2) by a hinge and data exchange between the display unit (6) and the control card (7) is provided by an electrical connection (FIG. 1, FIG. 2, FIG. 3, FIG. 4 and FIG. 5).

In an alternative embodiment of the present invention, the display unit (6) is mounted preferably on the front door (10) allowing access to the cooking chamber (FIG. 6) or on the window (12) on the upper door (11) (FIG. 7) covering the hob.

The household appliance (1) which is the object of the present invention enables the user to monitor the data compiled in the control card (7) from a distance, without any need to come near the household appliance (1) as well as offering the user the option of viewing the interior of the household appliance (1) and also endowing the household appliance (1) with a more aesthetic appearance.

1. A household appliance (1) comprising a body (2), a door (3) attached on the body (2) enabling user to have access inside the body (2), a window (12) positioned on the body (2) and/or on the door (3) allowing user to monitor interior of the body (2), and a control card (7) enabling the control of the household appliance (1) and characterized by a display unit (6) mounted on the window (12) allowing the user to monitor simultaneously the interior of body (2) through the window (12) and the data delivered by the control card (7).

2. A household appliance (1) as in claim 1, characterized by a display unit (6) produced of a transparent or semi-transparent material allowing light to pass through enabling user to view the interior of body (2).

3. A household appliance (1) as in claim 1 or 2, characterized by a display unit (6) employing LCD.

4. A household appliance (1) as in claims 1-3, wherein data exchange between the display unit (6) and the control card (7) is achieved by electrical and mechanical connections.

5. A household appliance (1) as in claims 1-4, wherein data exchange between the display unit (6) and the control card (7) is achieved by wireless data exchange methods such as infrared, radio signals, or bluetooth etc.

6. A household appliance (1) as in claims 1-5, utilized as a washer dryer characterized by a door (3) comprising an inner frame (4), an outer frame (5), and a panel (9) interposed between the inner frame (4) and the outer frame (5), and a display unit (6) engaged between the panel (9) and the outer frame (5).

7. A household appliance (1) as in claims 1-5, utilized as a cooking appliance and characterized by a display unit (6) installed on the window (12) on the front door (10).

8. A household appliance (1) as in claims 1-5, utilized as a cooking appliance and characterized by a display unit (6) installed on the window (12) on the upper door (11).
